(19) United States
(12) Patent Application Publication
(10) Pub. No.: US 2023/0084519 A1
(43) Pub. Date: Mar. 16, 2023

(54) AERODYNAMIC OPTIMIZATION OF THE SIZING AND BLADE DESIGNS OF COROTATING COAXIAL ROTORS

(71) Applicant: ST ENGINEERING AEROSPACE LTD., Paya Lebar, Singapore (SG)

(72) Inventor: Keen Ian CHAN, Singapore (SG)

(21) Appl. No.: 17/800,192

(22) PCT Filed: Dec. 14, 2020
(86) PCT No.: PCT/SG2020/050745

§ 371 Date: Aug. 16, 2022

(30) Foreign Application Priority Data
Oct. 29, 2020 (SG) 10202010770P

(51) Int. Cl. B64C 27/10; B64C 27/467

(52) U.S. Cl. CPC B64C 27/10; B64C 27/467

(57) ABSTRACT

A method and system for generating a set of values for respective ones of a set of parameters used in determining rotor blade profiles for a corotating coaxial rotor system. The method comprises establishing a ratio of respective desired thrusts of an upper rotor and a lower rotor of the corotating coaxial rotor system based on a desired performance of the corotating coaxial rotor system; and determining the set of values of the set of parameters from the desired thrusts ratio based on an equal rotation speed condition between the upper rotor and the lower rotor of the corotating coaxial rotor system, wherein the set of parameters includes torques of the upper rotor and the lower rotor.

### FIELD OF INVENTION

The present invention relates broadly to aerodynamic optimization of the sizing and blade designs of corotating coaxial rotors.

### BACKGROUND

Any mention and/or discussion of prior art throughout the specification should not be considered, in any way, as an admission that this prior art is well known or forms part of common general knowledge in the field.

Aerodynamic optimization of the sizing and blade designs of hovering coaxial rotors can be modelled as a pair of dissimilar actuator discs. For corotating coaxial rotors, i.e. the coaxial rotors rotate in the same rotational direction, rotational speeds of the upper and lower rotors must be the same in order to maintain a fixed index angle (the angle by which the upper rotor azimuthally leads or lags the lower rotor when corotating in the same rotational directions). Experimental studies of such corotating coaxial rotors in Ref. 2 imposed equality of torques for the coaxial rotors.

In previous work Ref. 1 and Ref. 3, a generalized momentum theory for coaxial rotors with dissimilar diameters and rotational speeds, with torques constrained to be equal, derived a cubic equation that relates the induced velocities of the upper and lower rotors, vᵤ and vₗ, as follows:

$$\frac{1}{{k}_{A}} {( 1 + \frac{{k}_{{V}_{T}}}{\sqrt{{k}_{A}}} )}^{2} {v}_{l}^{3} + [ 3 {( 1 + \frac{{k}_{{V}_{T}}}{\sqrt{{k}_{A}}} )}^{2} - ( \frac{\sqrt{{k}_{A}}}{{k}_{{V}_{T}}} + 1 ) \frac{{k}_{{V}_{T}}^{2}}{{k}_{A}} ] {v}_{u} {v}_{l}^{2} + [ 3 {{k}_{A} ( 1 + \frac{{k}_{{V}_{T}}}{\sqrt{{k}_{A}}} )}^{2} - 2 ( \frac{\sqrt{{k}_{A}}}{{k}_{{V}_{T}}} + 1 ) ( 1 + {k}_{{V}_{T}} \sqrt{{k}_{A}} ) \frac{{k}_{{V}_{T}}}{\sqrt{{k}_{A}}} ] {v}_{u}^{2} {v}_{l} + [ {( 1 + \frac{{k}_{{V}_{T}}}{\sqrt{{k}_{A}}} )}^{2} {k}_{A}^{2} - ( \frac{\sqrt{{k}_{A}}}{{k}_{{V}_{T}}} + 1 ) {( 1 + {k}_{{V}_{T}} \sqrt{{k}_{A}} )}^{2} ] {v}_{u}^{3} = 0$$

where k_{A} is the ratio of upper to lower rotor disc areas, and k_{VT} is the corresponding ratio for tip speeds. Being primarily directed at counter rotating coaxial rotors, i.e. the coaxial rotors rotate in the opposite rotational directions, the constraint on equal torques in Refs. 1 and 3 equated the magnitudes of torques for the coaxial rotors.

Embodiments of the present invention seek to improve the aerodynamic optimization of the sizing and blade designs of corotating coaxial rotors.

### SUMMARY

In accordance with a first aspect of the present invention, there is provided a method of generating a set of values for respective ones of a set of parameters used in determining rotor blade profiles for a corotating coaxial rotor system, the method comprising
establishing a ratio of respective desired thrusts of an upper rotor and a lower rotor of the corotating coaxial rotor system based on a desired performance of the corotating coaxial rotor system; and
determining the set of values of the set of parameters from the desired thrusts ratio based on an equal rotation speed condition between the upper rotor and the lower rotor of the corotating coaxial rotor system, wherein the set of parameters includes torques of the upper rotor and the lower rotor.

In accordance with a second aspect of the present invention, there is provided a system for generating a set of values for respective ones of a set of parameters used in determining rotor blade profiles for a corotating coaxial rotor system, the system comprising:
means for establishing a ratio of respective desired thrusts of an upper rotor and a lower rotor of the corotating coaxial rotor system based on a desired performance of the corotating coaxial rotor system; and
means for determining the set of values of the set of parameters from the desired thrusts ratio based on an equal rotation speed condition between the upper rotor and the lower rotor of the corotating coaxial rotor system, wherein the set of parameters includes torques of the upper rotor and the lower rotor.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing illustrating optimal dissimilar rotor diameters of a corotating coaxial rotor system resulting from momentum theory optimization according to an example embodiment.

FIG. 2 shows a schematic drawing illustrating aerodynamically optimized corotating dissimilar rotor blade geometries according to an example embodiment.

FIG. 3 shows a schematic drawing illustrating a coaxial actuator discs model with dissimilar diameters for use in an example embodiment.

FIG. 4 shows a flowchart illustrating a method of generating a set of values for respective ones of a set of parameters used in determining rotor blade profiles for a corotating coaxial rotor system, according to an example embodiment.

FIG. 5 shows a schematic drawing illustrating a system for generating a set of values for respective ones of a set of parameters used in determining rotor blade profiles for a corotating coaxial rotor system, according to an example embodiment.

### DETAILED DESCRIPTION

It has been recognized by the present inventor that for aerodynamic optimization of the sizing and blade designs of corotating coaxial rotors, there is no inherent requirement for the upper and lower rotors of a corotating pair of coaxial rotors to have the same torques. Rather, like the diameters of the upper and lower rotors, the torques of the upper and lower rotors can also be different for the aerodynamic optimization.

More specifically, in an example embodiment a generalized momentum theory has been developed for application in the aerodynamic optimization of the sizing and blade designs of corotating coaxial rotors with fixed index angles by imposing equality of rotational speeds, while lifting the constraint on equality of torques. Details of the generalized momentum theory are described as follows.

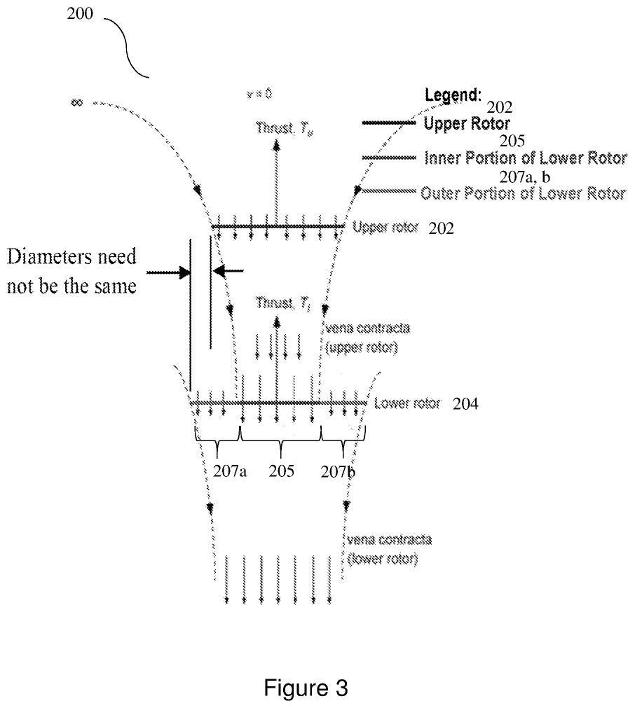

FIG. 3 shows a schematic drawing illustrating a corotating coaxial rotor system 200 modeled with a pair of dissimilar rotors 202, 204. FIG. 3 is used as a graphical example for describing the following method and it is understood that the method is not limited by FIG. 3.

According to various embodiments, the set of parameters of the method may include the following ratios:
Ratio of upper to lower rotor disc areas,

$${k}_{A} = \frac{{A}_{u}}{{A}_{l}} \qquad ( 1 )$$

Ratio of upper to lower rotor torques,

$${k}_{τ} = \frac{{τ}_{u}}{{τ}_{l}} \qquad ( 2 )$$

According to various embodiments, by applying the conservation of mass, momentum and energy, the induced power of the upper rotor may be derived according to the following:

Mass flow rate, i.e. the flow of mass through the upper rotor, may be given by:

\dot{m}ᵤ=ρAᵤvᵤ (3)

Accordingly, the momentum flux exiting the upper rotor may be given by:

(ρAᵤvᵤ)·2vᵤ=2ρAᵤvᵤ² (4)

Since the momentum flux exiting the upper rotor may also be equal to the thrust I′, of the upper rotor. Therefore, the thrust of the upper rotor may be expressed as:

Tᵤ=2ρAᵤvᵤ² (5)

Accordingly, the induced power Pᵤ of the upper rotor may be given by:

Pᵤ=Tᵤvᵤ=2ρAᵤvᵤ³ (6)

According to various embodiments, by applying the conservation of mass, momentum and energy, the induced power of the lower rotor may be derived according to the following:

The mass flow through the lower rotor may have two contributions:

Mass flow due to the induced velocity vₗ (=ρAₗvₗ)

Mass flow passed into the lower rotor from the upper rotor (=ρAᵤvᵤ)

Total mass flow through the lower rotor may thus be

\dot{m}ₗ=ρ(Aᵤvᵤ+Aₗvₗ) (7)

Conservation of momentum may be applied to the lower rotor. The physical statement may be that (Thrust=Momentum flux downstream−Momentum flux upstream). The resulting equation for the thrust Tₗ of the lower rotor may be

$$\begin{matrix}{T}_{l} = {\dot{m}}_{l} {w}_{l} - 2 ρ {A}_{u} {v}_{u}^{2} \\ = ρ ( {A}_{u} {v}_{u} + {A}_{l} {v}_{l} ) {w}_{l} - 2 ρ {A}_{u} {v}_{u}^{2}\end{matrix} \qquad ( 8 )$$

Expressing the equation for the thrust Ti in terms of k_{A} (ratio of upper to lower rotor disc areas),

Tₗ=ρAₗ(k_{A}vᵤ+vₗ)wₗ−2 ρAᵤvᵤ² (9)

The lower rotor includes two regions. The first may be the inner region which lies in the fully developed slipstream of the upper rotor. The area of this region may be given by:

$${A}_{{l}_{i}} = \frac{1}{2} {A}_{u}$$

The second may be the outer region which may be unaffected by the upper rotor. The area of this region may be given by:

$${A}_{{l}_{o}} = {A}_{l} - \frac{1}{2} {A}_{u}$$

To determine the induced power of the lower rotor, the individual powers for each of the inner and outer parts may be determined and then summed up.

The induced power of the inner part of the lower rotor, where thrust=Tₗ_{ᵢ}, may be given by:

Pₗ_{ᵢ}=Tₗ_{ᵢ}(2vᵤ+vₗ) (10)

where the 2vᵤ term is the contribution from the upper rotor.

In order to express Pₗ_{ᵢ} in terms of area ratio k_{A} and total lower rotor thrust Tₗ, thrust may be assumed to be weighted by area. This results in

$$\begin{matrix}{T}_{{l}_{i}} = \frac{{A}_{{l}_{i}}}{{A}_{l}} {T}_{l} \\ = \frac{\frac{1}{2} {A}_{u}}{{A}_{l}} {T}_{l} \\ = \frac{1}{2} {k}_{A} {T}_{l}\end{matrix} \qquad ( 11 )$$

Substituting back into Eq. (10),

$${P}_{{l}_{i}} = \frac{1}{2} {k}_{A} ( 2 {v}_{u} + {v}_{l} ) {T}_{l} \qquad ( 12 )$$

The induced power of the outer part of the lower rotor, where thrust=Tₗ_{ₒ}, may be given by:

Pₗ_{ₒ}=Tₗ_{ₒ}vₗ (13)

In order to express Pₗ_{ₒ} in terms of area ratio k_{A} and total lower rotor thrust Tₗ, thrust may again be assumed to be weighted by area. This results in

$$\begin{matrix}{T}_{{l}_{o}} = \frac{{A}_{{l}_{o}}}{{A}_{l}} {T}_{l} \\ = \frac{1}{{A}_{l}} ( {A}_{l} - \frac{1}{2} {A}_{u} ) {T}_{l} \\ = ( 1 - \frac{1}{2} {k}_{A} ) {T}_{l}\end{matrix} \qquad ( 14 )$$

Substituting back into Eq. (13),

$${P}_{{l}_{o}} = ( 1 - \frac{1}{2} {k}_{A} ) {T}_{l} {v}_{l} \qquad ( 15 )$$

Summing the contributions of the inner and outer regions, the total induced power of the lower rotor may be given by:

Pₗ=Pₗ_{ᵢ}+Pₗ_{ₒ}

Accordingly, by substituting from Eqs. (12) and (15), and re-arranging,

Pₗ=Tₗ(k_{A}vᵤ+vₗ) (16)

Pₗ may also be given by the change in kinetic energy from upstream of the lower rotor to far downstream:

$${P}_{l} = \frac{1}{2} ρ ( {A}_{u} {v}_{u} + {A}_{l} {v}_{l} ) {w}_{l}^{2} - {P}_{u} \qquad ( 17 )$$

According to various embodiments, the equality of rotational speeds condition may be expressed according to the following:

From Power=Torque×Rotational Speed, the ratio of upper to lower rotor powers may be given by:

$$\frac{{P}_{l}}{{P}_{u}} = \frac{{τ}_{l} {Ω}_{l}}{{τ}_{u} {Ω}_{u}} \qquad ( 18 )$$

In the equal rotational speeds condition, Wₗ=Wᵤ. Hence, the ratio of powers may become

$$\frac{{P}_{l}}{{P}_{u}} = \frac{{τ}_{l}}{{τ}_{u}} \qquad ( 19 )$$

Substituting using kₜ results in the following condition for equality of rotational speeds:

$${P}_{l} = \frac{1}{{k}_{τ}} {P}_{u} \qquad ( 20 )$$

Substituting from Eqs. (6) and (16), the condition for equality of rotational speeds may be expressed as

$${T}_{l} ( {k}_{A} {v}_{u} + {v}_{l} ) = \frac{1}{{k}_{τ}} {T}_{u} {v}_{u} \qquad ( 21 )$$

According to various embodiments, a cubic equation which relates to the induced velocities through the upper and lower rotors, vᵤ and vₗ respectively, may be developed according to the following:

Multiplying Eq. (9) by vᵤ(k_{A}vᵤ+vₗ) and re-arranging,

P₁[(1+k_{τ}k_{A})vᵤ+k_{τ}vₗ]=ρAₗ(k_{A}vᵤ+vₗ)²·(vᵤwₗ) (22)

Substituting the equality of rotational speeds Eq. (20) into the kinetic energy equation for Pₗ (Eq. (17)) and re-arranging,

$${P}_{l} ( 1 + {k}_{τ} ) = \frac{1}{2} ρ {A}_{l} ( {k}_{A} {v}_{u} + {v}_{l} ) {w}_{l}^{2} \qquad ( 23 )$$

Eq. (23) divided by Eq. (22), and re-arranging,

$${w}_{l} = 2 ( 1 + {k}_{τ} ) {v}_{u} \frac{{k}_{A} {v}_{u} + {v}_{l}}{[ ( 1 + {k}_{τ} {k}_{A} ) {v}_{u} + {k}_{τ} {v}_{l} ]} \qquad ( 24 )$$

Substituting the kinetic energy forms for power, Eqs. (6) and (17), into the equality of rotational speeds Eq. (20),

$$\frac{1}{2} ρ ( {A}_{u} {v}_{u} + {A}_{l} {v}_{l} ) {w}_{l}^{2} - 2 ρ {A}_{u} {v}_{u}^{3} = \frac{1}{{k}_{τ}} 2 ρ {A}_{u} {v}_{u}^{3} \qquad ( 25 )$$

After re-arranging,

$$( \frac{1}{{k}_{τ}} + 1 ) {v}_{u}^{3} = \frac{{w}_{l}^{2}}{4 {k}_{A}} ( {k}_{A} {v}_{u} + {v}_{l} ) \qquad ( 26 )$$

Substituting Eq. (24) for wₗ into Eq. (26), and after considerable re-arrangement, the cubic equation for the developed generalized momentum theory according to an example embodiment becomes

$$\frac{1}{{k}_{A}} {( 1 + {k}_{τ} )}^{2} {v}_{l}^{3} + [ 3 {( 1 + {k}_{τ} )}^{2} - ( \frac{1}{{k}_{τ}} + 1 ) {k}_{τ}^{2} ] {v}_{u} {v}_{l}^{2} + [ 3 {{k}_{A} ( 1 + {k}_{τ} )}^{2} - 2 ( \frac{1}{{k}_{τ}} + 1 ) ( 1 + {k}_{τ} {k}_{A} ) {k}_{τ} ] {v}_{u}^{2} {v}_{l} + [ {( 1 + {k}_{τ} )}^{2} {k}_{A}^{2} - ( \frac{1}{{k}_{τ}} + 1 ) {( 1 + {k}_{τ} {k}_{A} )}^{2} ] {v}_{u}^{3} = 0 \qquad ( 27 )$$

where vᵤ and vₗ are the induced velocities of the upper and lower rotors, respectively, k_{A} is the ratio of upper to lower rotor disc areas, and k_{τ} is the corresponding ratio for torques.

According to various embodiments, an equation for the power per unit thrust of the corotating coaxial system may be determined from the ratio of upper to lower rotor thrusts based on the equality of rotational speeds condition according to the following:

In general, for a given set of k_{A}, kₜ and either of vᵤ or vₗ, the cubic equation (27) may be solved for the other induced velocity.

The specified induced velocity may be determined from the selection of disc loading, which is usually decided upon during the initial stages of the conceptualizing of the corotating coaxial rotor system. In the present example, the selected disc loading may be for the upper rotor, denoted by (DL)ᵤ. The specified induced velocity of the upper rotor may thus be determined from

$${v}_{u} = \sqrt{\frac{{( D L )}_{u}}{2 ρ}} \qquad ( 28 )$$

The cubic equation (27) may now be solved for the induced velocity of the lower rotor vi.

The ratio of lower to upper rotor induced velocities may be denoted as kᵥ

$${k}_{v} ≡ \frac{{v}_{l}}{{v}_{u}} \qquad ( 29 )$$

From equality of rotational speeds, Eq. (21), which is reproduced as follows:

$${T}_{l} ( {k}_{A} {v}_{u} + {v}_{l} ) = \frac{1}{{k}_{τ}} {T}_{u} {v}_{u}$$

The ratio of upper to lower rotor thrusts, k_{T}, may be determined as

$${k}_{T} ≡ \frac{{T}_{u}}{{T}_{l}} = {k}_{τ} ( {k}_{A} + {k}_{v} ) \qquad ( 30 )$$

The upper rotor thrust, as a fraction of the total corotating coaxial system thrust, may thus be

$${k}_{T t o t} ≡ \frac{{T}_{u}}{{T}_{t o t}} = \frac{{k}_{T}}{{k}_{T} + 1} \qquad ( 31 )$$

The total corotating coaxial system induced power may be given by:

Pₜₒₜ=Pᵤ+Pₗ (32)

Substituting the equality of rotational speeds Eq. (20) for Pₗ,

$${P}_{t o t} = ( 1 + \frac{1}{{k}_{τ}} ) {P}_{u} \qquad ( 33 )$$

Knowing that Pᵤ=Tᵤvᵤ, and substituting Eqs. (31) and (28), the power per unit thrust of the corotating coaxial rotor system may be determined as follows:

$$\frac{{P}_{t o t}}{{T}_{t o t}} = ( 1 + \frac{1}{{k}_{τ}} ) \cdot {k}_{T t o t} \cdot \sqrt{\frac{{( D L )}_{u}}{2 p}} \qquad ( 34 )$$

It should be noted that the Eq. (34) for Pₜₒₜ/Tₜₒₜ is a function of three independent variables k_{A}, kₜ and (DL)ᵤ. These three variables will be the variables in the optimization to be described below, which seeks to minimize Pₜₒₜ/Tₜₒₜ, a condition which represents best hovering efficiency.

According to various embodiments, the power per unit thrust of the corotating coaxial rotor system may be optimized according to the following:

The objective of the optimization is to determine the combination of area ratio k_{A}, torque ratio kₜ and upper rotor disc loading (DL)ᵤ which maximizes the hovering efficiency (achieved by minimizing the power per unit thrust Pₜₒₜ/Tₜₒₜ) as determined by the generalized momentum theory representation of corotating coaxial rotor systems.

The optimization may be subjected to fulfilling two additional operational requirements:
Specified amount of thrust to be generated within a specified geometric footprint.
Specified thrust-sharing percentage between the upper and lower rotors. In the present example embodiment, this has been specified as 50-50 for consistency with Ref. 2. In other embodiments, this may be specified for other reasons including but not limited to: in the scenario that the corotating coaxial rotor system is one of a number of coaxial pairs in a multi-rotor VTOL UAV, safety requirements for recovery from failure of one of the two motors driving the two rotors in a coaxial pair. In this scenario, it is desirable for total thrust to be shared between the upper and lower rotors, such that each rotor is able to compensate for the loss of thrust in the event of failure of the other rotor.

These operational requirements may be quantified as:
Specified T_{tot,spec} (i.e. desired total thrust)
The footprint is specified through the disc area of the lower rotor, A_{l,spec} (i.e. maximum rotor diameter)
Specified k_{Ttot,spec}

Optimization with the quantified operational requirements may be solved by the method of calculus of variations using Lagrange multipliers. Two constraint equations may be defined. The first is in relation to the specified thrust and footprint. The second is in relation to the specified k_{Ttot,spec}.

By definition of disc loading,

$$\begin{matrix}{( D L )}_{u} = \frac{{T}_{u}}{{A}_{u}} \\ = \frac{{k}_{T t o t} {T}_{tot , spec}}{{k}_{A} {A}_{l , spec}}\end{matrix} \qquad ( 35 )$$

Hence, the first constraint equation may be given by:

$${( D L )}_{u} - \frac{{k}_{T t o t} {T}_{tot , spec}}{{k}_{A} {A}_{l , spec}} = 0 \qquad ( 36 )$$

The above Eq. (36) may be denoted in terms of a function ƒ₁.

ƒ₁[(DL)ᵤ,k_{A},k_{τ}]=0 (37)

From the specified thrust ratio,

k_{Ttot}=k_{Ttot,spec} (38)

Hence, the second constraint equation may be given by:

k_{Ttot}−k_{Ttot,spec}=0 (39)

The above Eq. (39) may be denoted in terms of a function ƒ₂.

ƒ₂[(DL)ᵤ,k_{A},k_{τ}]=0 (40)

An auxiliary function H may now be set up as

$$H = \frac{{P}_{t o t}}{{T}_{t o t}} + {λ}_{1} {f}_{1} + {h}_{2} {f}_{2} \qquad ( 41 )$$

where λ₁ and λ₂ are the Lagrange multipliers.

There may thus be 5 independent nonlinear equations to be solved for 5 variables: k_{A}, kₜ, (DL)ᵤ, λ₁ and λ₂. The 5 equations are:

$$\frac{\partial H}{\partial {k}_{A}} = 0 \qquad ( 42 )$$

$$\frac{\partial H}{\partial {k}_{τ}} = 0 \qquad ( 43 )$$

$$\frac{\partial H}{\partial {( D L )}_{u}} = 0 \qquad ( 44 )$$

$${f}_{1} [ {( D L )}_{u} , {k}_{A} , {k}_{τ} ] = 0 \qquad ( 45 )$$

$${f}_{2} [ {( D L )}_{u} , {k}_{A} , {k}_{τ} ] = 0 \qquad ( 46 )$$

The equations may be coded and solved numerically in MATLAB. The equation solver may also be developed in MATLAB, and may include
Genetic Algorithm (GA) technique for initial exploration of the design space, leading to the vicinity of the optimum point; or
Newton-Raphson technique, initialized using the vicinity point determined by GA, for final convergence, as it is well-known that this technique has very good convergence properties.

In an example design application, the developed generalized momentum theory according to an example embodiment is applied in the aerodynamic optimization of the sizing and blade designs of corotating coaxial rotors in conjunction with a calculus of variations, Lagrange multiplier optimization to determine the optimum combination of k_{A} and k_{τ} which achieve a specified total thrust at minimum total induced power of the corotating pair of coaxial rotors, while maintaining equal rotational speeds for the upper and lower rotors. The optimization according to the example embodiment using the developed generalized momentum theory is demonstrated in a design example taken from Ref. 2. The objective was to optimize the design of the corotating rotors of Ref. 2 for the intermediate total thrust condition of 366.3N (37.3 kgf or 82.3 lbf), which corresponds to C_{T}/σ=0.06 for each of the upper and lower rotors in FIG. 5(a) of Ref. 2.

The versatility of the developed generalized momentum theory for application in the aerodynamic optimization of the sizing and blade designs of corotating coaxial rotors according to the example embodiment, which has no constraints on similar diameters and torques, and which also allows thrust-sharing percentages between the upper and lower rotors to be independently specified (50-50 was used in the example design case, corresponding to k_{Ttot,spec}=0.5, for consistency with Ref. 2), can advantageously handle this design case. The problem statement for this momentum theory optimization example was defined as: To determine the ratios of rotor disc areas k_{A} and torques k_{τ}, of the upper and lower rotors of a corotating pair that minimizes total induced power to produce the design total thrust, or T_{tot,spec}, of 366.3N (37.3 kgf or 82.3 lbf) at static hover, subject to the conditions,

1) Equal rotational speeds for the upper and lower rotors (1200 rpm from Ref. 2), and

2) Maximum geometric footprint for rotor diameter=2.032 m (80 in), also from Ref. 2. This corresponded to A_{l,spec}=3.243 m² (5026.55 in²)

It is noted that 1200 rpm was used in the design example for consistency with Ref. (2) as an input to the optimization. In other example embodiments, the rotational speed may, for example, be specified for reasons including but not limited to achieving desired rotor tip Mach numbers. e.g. low subsonic Mach numbers for achieving low noise levels.

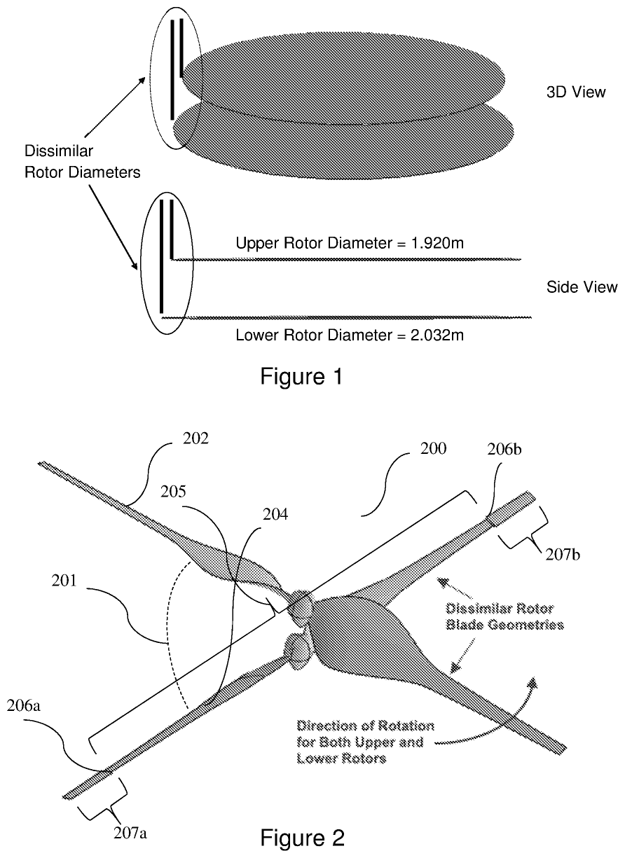

The results which achieved the required total thrust at minimum total induced power were k_{A}=0.8927 and k_{τ}=0.6845. The dissimilar pair of rotor disc areas and diameters is illustrated in FIG. 1. The key results are summarized as follows:
Optimized minimum total induced power: 2323.6 W (3.12 hp)
Upper rotor diameter and induced power: 1.920 m (75.6 in), 944.2 W (1.27 hp)
Lower rotor diameter and induced power: 2.032 m (80 in), 1379.4 W (1.85 hp)

The dissimilar rotor diameters and torques resulting from the aerodynamic optimization of the sizing and blade designs of corotating coaxial rotors according to the example embodiment can be used as inputs for the next level of detail: aerodynamic optimization resulting in the details of the geometries of the dissimilar upper and lower rotor blades. This was done using the Blade Element Momentum Theory (BEMT) method of Ref. 5. Specifically, the method of Ref. 5 contains the following generalizations A) to E):

A) Allows for dissimilar rotor blade diameters as specified inputs.

However, the BEMT method of Ref. 5 does not size or determine what these parameters should be. According to an example embodiment of the present invention, these parameters were sized beforehand applying the developed generalized momentum theory, and then used as inputs to the BEMT method of Ref. 5.

B) A constraint equation that equates the torques of the upper and lower rotors.

According to an example embodiment of the present invention, this equation is modified to allow for dissimilar rotor torques by applying the factor k_{τ} to the lower rotor torque in a newly developed BEMT method, as expressed by Eq. (47):

$${C}_{{P}_{i}}^{u} + {C}_{{P}_{0}}^{u} = {k}_{τ} ( {C}_{{P}_{i}}^{l} + {C}_{{P}_{0}}^{l} ) \frac{{ζ}_{R}^{5}}{{ζ}_{Ω}^{2}} \qquad ( 47 )$$

where C_{P}_{ᵢ} and C_{P}_{₀} are the induced and profile power coefficients, with the superscripts u or l denoting upper or lower rotor respectively. ζ_{R} is the ratio of lower to upper rotor radii and ζ_{Ω} is the ratio of upper to lower rotor rotational speeds.

C) Interference inflow to each rotor is more rigorously determined via the Biot-Savart vortex filament model.

D) Allows the lower rotor to have dissimilar induced inflows for its inner and outer regions.

E) Thrust distribution over the lower rotor need not be area-weighted over the rotor disc plane.

The index angle can be chosen to provide additional benefits in aeroacoustics and/or aerodynamics. From an aeroacoustics consideration, corotating rotors inherently do not generate the noise source of pressure impulses of counterrotating rotors when the upper and lower rotor blades cross each other as they rotate in opposite directions, as described in Refs. 6 and 7. Furthermore, the computations of Ref. 8 indicate that, when each of the upper and lower rotors has two blades, index angles in the region of 90° produce destructive interferences between the acoustic waves from the corotating upper and lower rotor blades, which weakens the resulting aerodynamic noise. In consideration of these findings, an index angle of 90° (see numeral 201 in FIG. 2) is tentatively specified as a geometric parameter according to a non-limiting example embodiment.

The resulting corotating pair 200 comprising dissimilar upper and lower rotor blades 202, 204, respectively, is illustrated in FIG. 2, with the chord distribution, the twist distribution, the pitch angle distribution, and the airfoil distribution etc. for the rotor blades 202, 204 profiles, using the BEMT method according to an example embodiment.

It can be seen in FIG. 2 that the lower rotor 204 has a kink 206a, b at the outboard region. This marks the boundary of the downwash from the upper rotor 202 where the downwash contacts with the lower rotor 204. For the region 205 inboard of this kink 206a, b, this is immersed in the downwash of the upper rotor 202, as illustrated in FIG. 3, and generates thrust less efficiently due to this interference with the upper rotor. The optimizer according to the example embodiment assigns the inboard region 205 to generate less thrust as compared to the outboard region 207a, b, as a means to reduce the amount of power expended on the inherently less efficient inboard region 205. The step change in thrust between the inboard region 205 immersed in the downwash of the upper rotor 202 and the outboard region 207a, b outside of the downwash results in a step change in (optimized) blade chord distribution. Accordingly, the blade profile for the lower rotor 204 contains the kink 206a, b that reflects this step change.

The hovering efficiency is assessed by defining Figure of Merit (FM) as

$$F M = \frac{Ideal Power from Generalized Coaxial Momentum Theory}{Actual Power}$$

A pre-optimization value of FM using the above definition was determined from experimental measurements of the corotating rotors of Ref 2. As the corotating rotors of Ref. 2 were of equal diameters, rotational speeds and torques, the ideal power can be determined from an earlier momentum theory of Ref. 4, which gives the induced power coefficient as

$${C}_{{P}_{i}} = 1.2657 \frac{{C}_{{T}_{i}}^{3 / 2}}{\sqrt{2}} [ {( \frac{{C}_{{T}_{u}}}{{C}_{{T}_{l}}} )}^{3 / 2} + 1 ]$$

where C_{P}_{ᵢ} is the induced power coefficient of the coaxial pair, C_{T}_{ᵤ} and C_{T}_{ᵢ} are the thrust coefficients of the upper and lower rotor respectively.

The FM for the corotating rotors of Ref. 2, as well as the FM after optimization according to the example embodiment of the present invention, are summarized in Table 1. The disk loadings are approximately equal, thus allowing for comparisons of FM to be made. It can be seen that in the example embodiment of the present invention, despite negative biasing from operating at lower Reynolds numbers, the optimization is still able to achieve a FM which is substantially higher than in Ref. 2.

TABLE 1
Comparison of Figure of Merit (FM)

| | Disk Loading (lb/ft² or N/m²) | | | | | | |
|---|---|---|---|---|---|---|---|
| | Upper Rotor | | Lower Rotor | | Reynolds Number | | |
| | English | Metric | English | Metric | Upper Rotor | Lower Rotor | FM |
| Uehara et al., | 1.242 | 59.476 | 1.117 | 53.483 | 490,000 | 490,000 | 0.50 |
| 2020 (Ref. 2) | | | | | (at 0.75R) | (at 0.75R) | |
| Present | 1.179 | 56.434 | 1.307 | 62.580 | 260,000 | 180,000 | 0.73 |
| | | | | | (Uniform) | (Uniform for | |
| | | | | | | Inner Portion) | |
| | | | | | | 270,000 | |
| | | | | | | (Uniform for | |
| | | | | | | Outer Portion) | |

It is noted that in a different example embodiment, the index angle may be computed as part of the optimization, rather than being pre-specified. Also, in a different example embodiment aerodynamic considerations may be used in pre-specifying or in optimizing the index angle. For example, Ref. 2 reports that much smaller index angles in the region of 10° can yield benefits in additional power loading.

Also, the number of blades of the upper and lower rotors may be different from two, and/or the upper and lower rotors may have different numbers of blades, e.g upper rotor two blades, lower rotor three blades etc., in different example embodiments

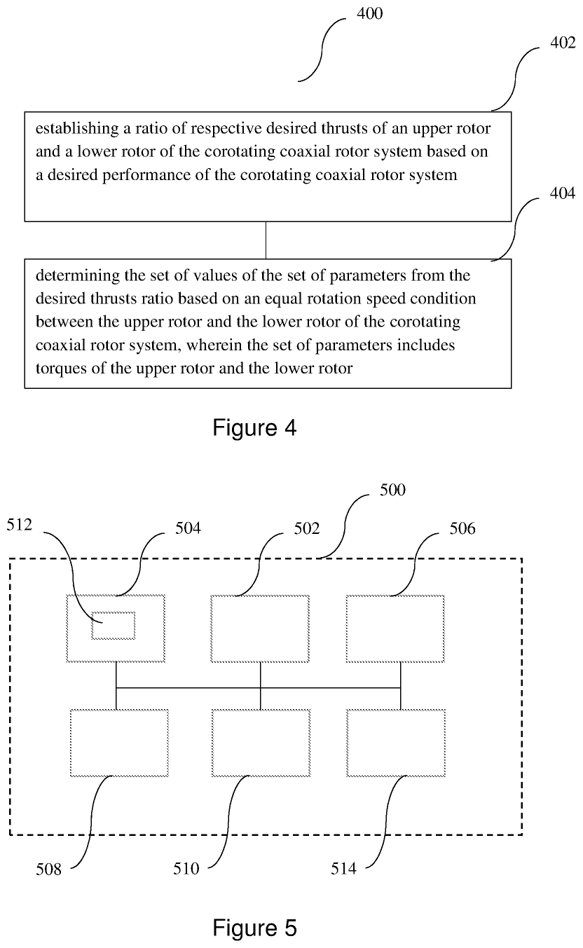

FIG. 4 shows a flowchart 400 illustrating a method of generating a set of values for respective ones of a set of parameters used in determining rotor blade profiles for a corotating coaxial rotor system, according to an example embodiment. At step 402, a ratio of respective desired thrusts of an upper rotor and a lower rotor of the corotating coaxial rotor system is established based on a desired performance of the corotating coaxial rotor system. At step 404, the set of values of the set of parameters is determined from the desired thrusts ratio based on an equal rotation speed condition between the upper rotor and the lower rotor of the corotating coaxial rotor system, wherein the set of parameters includes torques of the upper rotor and the lower rotor.

The method may comprise establishing a maximum rotor diameter for the corotating coaxial rotor system prior to determining the set of values for the set of parameters and determining the set of values for the set of parameters comprises using the maximum rotor diameter.

The method may comprise establishing a desired total thrust for the corotating coaxial rotor system prior to determining the set of values for the set of parameters and determining the set of values for the set of parameters comprises using the desired total thrust.

The method may comprise choosing an index angle of the corotating coaxial rotor system prior to determining the set of values for the set of parameters.

Determining the set of values for the set of parameters may comprise determining an index angle of the corotating coaxial rotor system.

Determining the set of values for the set of parameters may comprise optimizing the set of values based on minimizing total induced power for static hover.

The set of parameters may include a ratio of respective rotor disc areas of the upper rotor and the lower rotor of the corotating coaxial rotor system. The set of parameters may include upper rotor diameter and lower rotor diameter.

The method may comprise assigning an inbound region of the lower rotor from a boundary of downwash from the upper rotor less thrust compared to an outboard region of the lower rotor from the boundary of downwash from the upper rotor. The set of parameters include a step change in chord of the lower rotor.

The ratio of respective desired thrusts of an upper rotor and a lower rotor of the corotating coaxial rotor system may be 1:1.

The torques of the upper rotor and the lower rotor may be included in the set of parameters as a ratio of the torque of the upper rotor and the torque of the lower rotor.

FIG. 5 shows a schematic drawing illustrating a system 500 for generating a set of values for respective ones of a set of parameters used in determining rotor blade profiles for a corotating coaxial rotor system, according to an example embodiment. The system 500 comprises means for establishing a ratio of respective desired thrusts, 502, of an upper rotor and a lower rotor of the corotating coaxial rotor system based on a desired performance of the corotating coaxial rotor system; and means for determining the set of values of the set of parameters, 504, from the desired thrusts ratio based on an equal rotation speed condition between the upper rotor and the lower rotor of the corotating coaxial rotor system, wherein the set of parameters includes torques of the upper rotor and the lower rotor.

The system may comprise means for establishing a maximum rotor diameter, 506, for the corotating coaxial rotor system prior to determining the set of values for the set of parameters and determining the set of values for the set of parameters comprises using the maximum rotor diameter.

The system may comprise means for establishing a desired total thrust, 508, for the corotating coaxial rotor system prior to determining the set of values for the set of parameters and determining the set of values for the set of parameters comprises using the desired total thrust.

The system may comprise means for choosing an index angle, 510, of the corotating coaxial rotor system prior to determining the set of values for the set of parameters.

The means for determining the set of values for the set of parameters, 504, may be configured for determining an index angle of the corotating coaxial rotor system.

The means for determining the set of values for the set of parameters, 504, may comprise means for optimizing the set of values, 512, based on minimizing total induced power for static hover.

The set of parameters may include a ratio of respective rotor disc areas of the upper rotor and the lower rotor of the corotating coaxial rotor system. The set of parameters may include upper rotor diameter and lower rotor diameter.

The system may comprise means for assigning, 514, an inbound region of the lower rotor from a boundary of downwash from the upper rotor less thrust compared to an outboard region of the lower rotor from the boundary of downwash from the upper rotor. The set of parameters may include a step change in chord of the lower rotor.

The ratio of respective desired thrusts of an upper rotor and a lower rotor of the corotating coaxial rotor system may be 1:1.

The torques of the upper rotor and the lower rotor may be included in the set of parameters as a ratio of the torque of the upper rotor and the torque of the lower rotor.

Aspects of the systems and methods described herein such as the aerodynamic optimization of the sizing and blade designs of corotating coaxial rotors and the aerodynamic optimization resulting in the details of the geometries of the dissimilar upper and lower rotor blades, for example the means for establishing a ratio of respective desired thrusts, 502, the means for determining the set of values of the set of parameters, 504, the means for establishing a maximum rotor diameter, 506, the means for establishing a desired total thrust, 508, the means for choosing an index angle, 510, the means for optimizing the set of values, 512, and the means for assigning, 514, may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize.

The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

### REFERENCES

Ref 1—Chan, K. I., “Method and System for Generating a Set of Values for Respective Ones of a Set of Parameters Used in Determining Rotor Blade Profiles for a Coaxial Rotor System,” International Patent Application Number PCT/S G2015/050489, December 2015
Ref 2—Uehara, D., Sirohi, J. and Bhagwat, M. J., “Hover Performance of Corotating and Counterrotating Coaxial Rotors,” Journal of the American Helicopter Society, Vol. 65, (1), January 2020, pp. 012006. doi: 10.4050/JAHS.65.012006
Ref 3—Chan, K. I., “Generalized Aerodynamic Optimization of Hovering Coaxial Rotor Blades,” Journal of the American Helicopter Society, Vol. 64, (2), April 2019, pp. 022006. doi: 10.4050/JAHS 0.64.022006
Ref 4—Leishman, J. G. and Syal, M., “Figure of Merit Definition for Coaxial Rotors,” Journal of the American Helicopter Society, Vol. 53, (3), July 2008, pp. 290-300. doi: 10.4050/JAHS.53.290
Ref 5—Rand, O. and Khromov, V., “Aerodynamic Optimization of Coaxial Rotor in Hover and Axial Flight,” 27th International Congress of the Aeronautical Sciences, Nice, France, September 19-24, 2010.
Ref 6—Lakshminarayan, V. K. and Baeder, J. D., “High-Resolution Computational Investigation of Trimmed Coaxial Rotor Aerodynamics in Hover,” Journal of the American Helicopter Society, Vol. 54, (4), October 2009, pp. 042008. doi: 10.4050/JAHS.54.042008
Ref 7—Schatzman, N. L., “Aerodynamics and Aeroacoustic Sources of a Coaxial Rotor,” PhD Thesis, Georgia Institute of Technology, May 2018
Ref 8—Shubham, “Computational Aeroacoustic Investigation of Co-rotating Rotors for Urban Air Mobility,” Masters Thesis, Delft University of Technology, January 2020

1. A method of generating a set of values for respective ones of a set of parameters used in determining rotor blade profiles for a corotating coaxial rotor system, the method comprising:
establishing a ratio of respective desired thrusts of an upper rotor and a lower rotor of the corotating coaxial rotor system based on a desired performance of the corotating coaxial rotor system; and
determining the set of values of the set of parameters from the desired thrusts ratio based on an equal rotation speed condition between the upper rotor and the lower rotor of the corotating coaxial rotor system, wherein the set of parameters includes torques of the upper rotor and the lower rotor.

2. The method of claim 1, comprising establishing a maximum rotor diameter for the corotating coaxial rotor system prior to determining the set of values for the set of parameters and determining the set of values for the set of parameters comprises using the maximum rotor diameter.

3. The method of claim 1, comprising establishing a desired total thrust for the corotating coaxial rotor system prior to determining the set of values for the set of parameters and determining the set of values for the set of parameters comprises using the desired total thrust.

4. The method of claim 1, comprising choosing an index angle of the corotating coaxial rotor system prior to determining the set of values for the set of parameters.

5. The method of claim 1, wherein determining the set of values for the set of parameters comprises determining an index angle of the corotating coaxial rotor system.

6. The method of claim 1, wherein determining the set of values for the set of parameters comprises optimizing the set of values based on minimizing total induced power for static hover.

7. The method of claim 1, wherein the set of parameters include a ratio of respective rotor disc areas of the upper rotor and the lower rotor of the corotating coaxial rotor system, and wherein the set of parameters include upper rotor diameter and lower rotor diameter.

8. (canceled)

9. The method of claim 1, comprising assigning an inbound region of the lower rotor from a boundary of downwash from the upper rotor less thrust compared to an outboard region of the lower rotor from the boundary of downwash from the upper rotor, and wherein the set of parameters include a step change in chord of the lower rotor.

10. (canceled)

11. The method of claim 1, wherein the ratio of respective desired thrusts of an upper rotor and a lower rotor of the corotating coaxial rotor system is 1:1.

12. The method of claim 1, wherein the torques of the upper rotor and the lower rotor are included in the set of parameters as a ratio of the torque of the upper rotor and the torque of the lower rotor.

13. A system for generating a set of values for respective ones of a set of parameters used in determining rotor blade profiles for a corotating coaxial rotor system, the system comprising:
means for establishing a ratio of respective desired thrusts of an upper rotor and a lower rotor of the corotating coaxial rotor system based on a desired performance of the corotating coaxial rotor system; and
means for determining the set of values of the set of parameters from the desired thrusts ratio based on an equal rotation speed condition between the upper rotor and the lower rotor of the corotating coaxial rotor system, wherein the set of parameters includes torques of the upper rotor and the lower rotor.

14. The system of claim 13, comprising means for establishing a maximum rotor diameter for the corotating coaxial rotor system prior to determining the set of values for the set of parameters and determining the set of values for the set of parameters comprises using the maximum rotor diameter.

15. The system of claim 13, comprising means for establishing a desired total thrust for the corotating coaxial rotor system prior to determining the set of values for the set of parameters and determining the set of values for the set of parameters comprises using the desired total thrust.

16. The system of claim 13, comprising means for choosing an index angle of the corotating coaxial rotor system prior to determining the set of values for the set of parameters.

17. The system of claim 13, wherein the means for determining the set of values for the set of parameters is configured for determining an index angle of the corotating coaxial rotor system.

18. The system of claim 13, wherein the means for determining the set of values for the set of parameters comprises means for optimizing the set of values based on minimizing total induced power for static hover.

19. The system of claim 13, wherein the set of parameters include a ratio of respective rotor disc areas of the upper rotor and the lower rotor of the corotating coaxial rotor system, and wherein the set of parameters include upper rotor diameter and lower rotor diameter.

20. (canceled)

21. The system of claim 13, comprising means for assigning an inbound region of the lower rotor from a boundary of downwash from the upper rotor less thrust compared to an outboard region of the lower rotor from the boundary of downwash from the upper rotor, and wherein the set of parameters include a step change in chord of the lower rotor.

22. (canceled)

23. The system of claim 13, wherein the ratio of respective desired thrusts of an upper rotor and a lower rotor of the corotating coaxial rotor system is 1:1.

24. The system of claim 13, wherein the torques of the upper rotor and the lower rotor are included in the set of parameters as a ratio of the torque of the upper rotor and the torque of the lower rotor.
